(19) United States
(12) Patent Application Publication
(10) Pub. No.: US 2021/0027223 A1
(43) Pub. Date: Jan. 28, 2021

(54) SYSTEM, CONTROL APPARATUS, METHOD THAT CONTROLS MINING UNIT, AND PROGRAM

(71) Applicant: NEC Corporation, Minato-ku, Tokyo (JP)

(72) Inventor: Toshio KOIDE, Tokyo (JP)

(73) Assignee: NEC Corporation, Minato-ku, Tokyo (JP)

(21) Appl. No.: 16/957,268

(22) PCT Filed: Dec. 28, 2017
(86) PCT No.: PCT/JP2017/047212

§ 371 Date: Jun. 23, 2020

(51) Int. Cl. G06Q 10/06; G06Q 50/06; G05B 19/042; H02J 7/00; H02J 3/38

(52) U.S. Cl. CPC G06Q 10/06312; G06Q 50/06; G06Q 20/0655; H02J 7/0013; H02J 3/381; G05B 19/042

(57) ABSTRACT

A system comprises: a plurality of mining units configured to perform mining of virtual currency, and a control apparatus configured to control to activate or deactivate the plurality of mining units based on surplus power information provided from a power plant, and on consumed power information by each of the plurality of mining units.

### TECHNICAL FIELD

The present invention relates to a system, a control apparatus, a method that controls mining unit, and a program.

### BACKGROUND ART

Since a power demand constantly changes, an output of a power plant(s) is adjusted according to the power demand. A type(s) of a power source(s) used in the power plants includes nuclear power, hydroelectric, thermal, solar, and wind power, etc. Nuclear power and hydroelectric power are capable of outputting a constant power, but have a characteristic that output control is difficult. Thermal power is characterized in that the output control is easy, but a cost is relatively high, and a load burden is imposed on an environment. The solar power and the wind power are characterized in that the load burden on the environment is small, but the power output changes greatly, so that it is difficult to control the power.

An Electric power company and a consumer(s) are striving to balance a total of a supply power(s) with an actual power demand. In order to achieve the above balance, the electric power company (supply side) estimate a demand and control a power generation capacity(es) systematically. For example, as shown in FIG. 20, the electric power company treats a power source(s), such as nuclear power or hydroelectric power whose output is difficult to control as a base power and let them supply a constant power. The electric power company performs a control such that a power that cannot be supplied by the base power is supplemented by thermal power or the like.

Concretely, in a case where more demand is estimated in a season or a time zone, the electric power company operates many thermal power plants to satisfy the power demand. On the other hand, in a case where it is determined that the demand is small, the electric power company stops an operation(s) of most thermal power plants while operating a part of thermal power plants. As described above, the electric power company struggles to maintain the balance between the supply power and the demand power.

In addition, in a case where the power is a surplus, the electric power company raises water using the surplus power and uses the raised water for power generation (referred to as pumped-storage power generation).

As for consumers' (demand side) initiatives, they are achieved including adjusting a required power to a power supply grid using a battery storage(s) at each home using a smart grid, etc., and adjusting an energy consumption such as an air conditioning through an energy management for an entire building.

Patent Literature 1 and 2 disclose techniques relating to utilization of the surplus power generated by solar power or the like.

### CITATION LIST

### Patent Literature

[PTL 1] Japanese Patent Publication No. 2016-103965A
[PTL 2] Japanese Patent Publication No. 2015-233413A

### SUMMARY

### Technical Problem

Each disclosure of the above-listed Citation List is incorporated herein in its entirety by reference. The following analysis has been made by the inventors.

As mentioned above, the power company struggles to balance the supply and demand power. Here, a stable power supply is required for the electric power company (supply side). Therefore, the electric power company usually does not generate the power below the estimated demand power, but generates the power with some margin. Such power generation inevitably generates “surplus power” which is an excess power that is higher than the demand power, and the processing of the surplus power becomes a problem. The surplus power is the power that is not supplied to the consumers. Also, the generated power (AC power) cannot be stored basically. As described above, countermeasures such as using the surplus power for pumped-storage power generation have been made, however there is a limit to such measures. Therefore, the surplus power becomes a factor that increases the power generation cost in the power company. Such increase in cost is ultimately reflected in an electricity bill, and a burden on the consumers increases.

It is the main object of the present invention to provide a system, a control apparatus, a method for controlling mining unit, and a program that contribute to realize a low cost power generation.

### Solution to Problem

According to a first aspect of the present invention or disclosure, there is provided a system, a plurality of mining units configured to perform mining of virtual currency, and a control apparatus configured to control to activate or deactivate the plurality of mining units based on surplus power information provided from a power plant, and on consumed power information by each of the plurality of mining units.

According to a second aspect of the present invention or disclosure, there is provided a control apparatus configured to control a plurality of mining units configured to perform mining of virtual currency, wherein the control apparatus is: configured to control to activate or deactivate the plurality of mining units based on surplus power information provided from a power plant, and on consumed power information consumed by each of the plurality of mining units.

According to a third aspect of the present invention or disclosure, there is provided a method that controls mining unit for a control apparatus configured to control a plurality of mining units configured to perform mining of virtual currency, the method comprising: a step of obtaining surplus power information provided from a power plant, a step of controlling to control to activate or deactivate the plurality of mining units based on the surplus power information and on consumed power information consumed by each of the plurality of mining units.

According to a fourth aspect of the present invention or disclosure, there is provided a program that causes a computer installed on a control apparatus configured to control a plurality of mining units configured to perform mining of virtual currency, the program comprising: a process of obtaining a surplus power information provided from a power plant, a process of controlling to control to activate or deactivate the plurality of mining units based on the surplus power information and on consumed power information consumed by each of the plurality of mining units.

The program can be recorded on a computer-readable storage medium. The storage medium can be set to a non-transient (non-transient) one such as a semiconductor memory, a hard disk, a magnetic recording medium, or an optical recording medium. The present invention can also be embodied as a computer program product.

### Advantageous Effects of Invention

According to each aspect of the present invention or disclosure, there is provided a system, a control apparatus, a method for controlling mining unit, and a program that contribute to realize a low cost power generation.

### BRIEF DESCRIPTION OF DRAWINGS

FIG. 1 is a diagram showing an outline of one example embodiment.

FIG. 2 is a diagram showing an example of an outline configuration of a surplus power absorption system according to a first exemplary embodiment.

FIG. 3 is a diagram showing a process configuration of a control apparatus according to the first exemplary embodiment.

FIG. 4 is a diagram showing an example of a mining unit information stored in a storage part.

FIG. 5 is a diagram showing an example of a process configuration of a mining unit according to the first exemplary embodiment.

FIG. 6 is a diagram showing a hardware configuration of a control apparatus according to the first exemplary embodiment.

FIG. 7 is a sequence diagram showing an operation of the surplus power absorption system according to the first exemplary embodiment.

FIG. 8 is a sequence diagram showing the operation of the surplus power absorption system according to the first exemplary embodiment.

FIG. 9 is a diagram showing an outline configuration of the surplus power absorption system according to a second exemplary embodiment.

FIG. 10 is a diagram showing an outline configuration of the surplus power absorption system according to a third exemplary embodiment.

FIG. 11 is a flowchart diagram showing an example of an operation of a mining unit control part according to the third exemplary embodiment.

FIG. 12 is a diagram showing an example of a report information from the control apparatus to a power plant.

FIG. 13 is a diagram showing an example of a process configuration of the control apparatus according to a fourth exemplary embodiment.

FIG. 14 is a flowchart diagram showing an example of an operation of a determination part on excess/shortage of mining units according to the fourth exemplary embodiment.

FIG. 15 is a diagram showing an example of a relationship between the surplus power and an available power.

FIG. 16 is a diagram showing an example of an outline configuration of the surplus power absorption system according to a fifth exemplary embodiment.

FIG. 17 is a diagram showing an example of the mining unit information according to the fifth exemplary embodiment.

FIG. 18 is a diagram showing an example of an operation of a mining unit control part according to the fifth exemplary embodiment.

FIG. 19 is a diagram showing an example of the operation of the mining unit control part according to the fifth exemplary embodiment.

FIG. 20 is a diagram explaining a power generation by an electric power company.

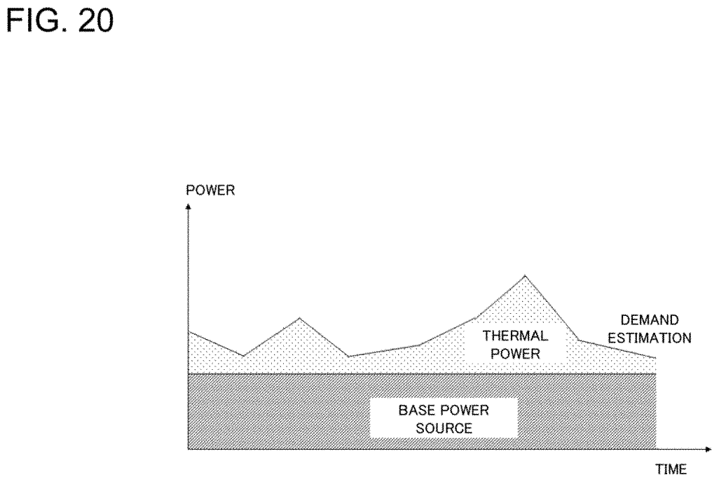

### DESCRIPTION OF EMBODIMENTS

First, an outline of one exemplary embodiment will be described. The reference symbols of the drawings appended to this outline are added for the sake of convenience to each element as an example for aiding understanding, and the description of the outline is not intended to limit any way. Also, a connection line between blocks in each block diagram includes both bidirectional and unidirectional directions. The unidirectional arrows schematically indicate the flow of main signals (data), and do not exclude bidirectionality. In addition, although not explicitly disclosed, in the circuit diagrams, block diagrams, internal configuration diagrams, connection diagrams and the like, shown in the disclosure of the present disclosure, input ports and output ports are present at respective input terminals and output terminals of each connection line. The same applies for input/output interfaces.

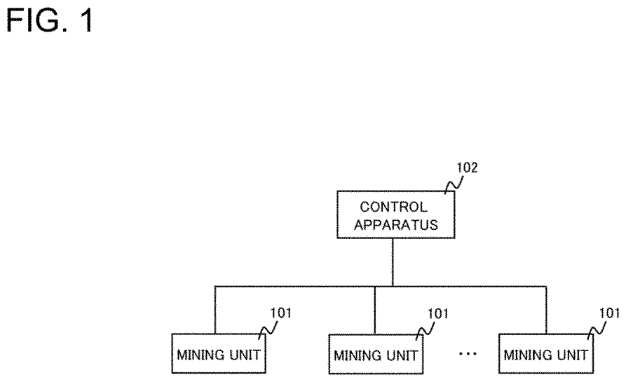

A system (surplus power absorption system) according to one exemplary embodiment comprises a plurality of mining units (i.e. mining facility units) 101 and a control apparatus 102 (refer to FIG. 1). Each of the plurality of mining units 101 performs virtual currency mining operation. The control apparatus 102 controls an activation and deactivation for the plurality of mining units based on surplus power information provided from a power plant, and consumed power information of each of the plurality of mining units 101.

In the above system, the virtual currency (for example, Bitcoin) is mined by utilizing the surplus power generated in the power plant. At this time, the control apparatus 102 controls the activation and deactivation of the mining units 101 so as to the surplus power supplied from the power plant is consumed by the power used by mining operation of the mining units 101. With such a configuration, in the above system, the surplus power can be converted into a monetary value of the virtual currency, and a cost required for the surplus power can be recovered. That is, a low-cost power generation can be realized. Also, since a cost of thermal power and the like that is relatively high which results in the load to an environment can be suppressed, the above mentioned system can reduce the load to the environment. Also, since the surplus power is converted into the monetary value, a need for pumped-storage power generation or the like for the purpose of utilizing the surplus power is eliminated or reduced.

Hereinafter, concrete exemplary embodiments will be described in more detail with reference to the drawings. In each exemplary embodiment, the same component elements are denoted by the same reference numerals, and the description thereof will be omitted.

### First Exemplary Embodiment

A first exemplary embodiment will be described in more detail with reference to the drawings.

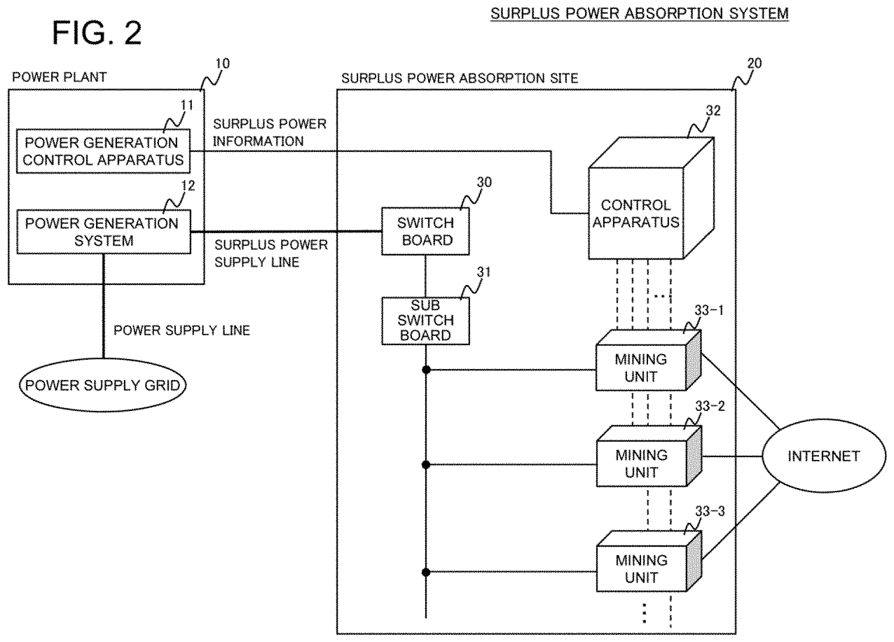

FIG. 2 is a diagram showing an example of an outline configuration of the surplus power absorption system according to the first exemplary embodiment. By referring to FIG. 2, the surplus power absorption system comprises a surplus power absorption site 20 connected to a power plant 10. A power generated by the power plant 10 is supplied to the consumers via a power supply line and a power supply grid. Also, the power plant 10 and the surplus power absorption site 20 are connected by a surplus power supply line, and a part of the power generated by the power plant 10 is supplied to the surplus power absorption site 20 via the surplus power supply line.

The surplus power absorption system according to the first exemplary embodiment comprises a connection for realizing information transmission between the power plant 10 and the surplus power absorption site 20. For example, the power plant 10 and the surplus power absorption site 20 are connected by wire or wirelessly.

The surplus power absorption site 20 is located in the vicinity the power plant 10. The reason for locating the surplus power absorption site 20 in the vicinity of the power plant 10 is that, in a case where a distance between the power plant 10 and the surplus power absorption site 20 becomes longer, a loss of the power supplied from the power plant 10 increases, which causes inefficiency. Note that the surplus power absorption site 20 may of course be located in a site of the power plant 10.

As shown in FIG. 2, the power plant 10 comprises a power generation control apparatus 11 and a power generation system 12.

The power generation control apparatus 11 is an apparatus for controlling power generation of the power generation system 12. The power generation system 12 is a power source(s) by nuclear power, hydroelectric power, thermal power, and the like. The power generation system 12 may be a single power source such as hydroelectric power or combination of a plurality of power sources. Any power sources can be used for the power generation system 12 as long as the power source can supply the power estimated to be consumed by the consumers. However, considering the load to the environment, it is preferred to use the power source such as hydroelectric power instead of thermal power.

The power generation control apparatus 11 controls an amount of power generated by the power generation system 12 based on a demand estimation input in advance by the electric power company or the like. Also, the power generation control apparatus 11 calculates a difference between the amount of power generated by the power generation system 12 and a power supplied to the consumers via the power supply grid as a surplus power. The power generation control apparatus 11 notifies to the surplus power absorption site 20 on the calculated surplus power as “surplus power information”.

Here, a configuration and an operation (processing module) of the power generation control apparatus 11 and the power generation system 12 included in the power plant 10 are evident to those skilled in the art, further description will be omitted.

As shown in FIG. 2, the surplus power absorption site 20 comprises a switch board 30, a sub switch board 31, a control apparatus 32, and a plurality of mining units 33-1 to 33-N (N is an integer of 2 or more; applies hereinafter same). Note that, in the following description, in a case where there is no special reason to distinguish the mining units 33-1 to 33-N, the mining units 33-1 to 33-N are simply referred to as “mining unit 33”. Similarly, in a case where there is no special reason to distinguish each component, the component is represented by a number described before hyphen.

The switch board 30 is connected to the surplus power supply line, and converts high-voltage power supplied from the power plant 10 into low-voltage power.

The sub switch boards 31 are connected to each of the plurality of mining units 33 and supply power to each of the mining units 33. Although power is also supplied to the control apparatus 32 via the switch board 31, the consumed power of the control apparatus 32 is sufficiently smaller than a consumed power of the mining unit 33, and can be ignored.

The control apparatus 32 is a means that controls the entire surplus power absorption site 20. For example, the control apparatus 32 controls the mining units 33. More concretely, the control apparatus 32 obtains “surplus power information” from the power plant 10 and controls activation and deactivation of the mining units 33 using the information. The control apparatus 32 also manages the virtual currencies obtained by mining operation of the mining units 33 described later, and controls the switch board 30 and the like as necessary.

Each of the mining units 33 is a means for mining the virtual currency. In the present disclosure, the mining units 33 will be described as mining Bitcoin (Bitcoin). However, it is needless to say that the virtual currency to be mined is not limited to Bitcoin. The mining units 33 may obtain other virtual currency such as Ethereum as a target for mining.

As shown in FIG. 2, each of the mining units 33 is connected to Internet. The mining unit 33 obtains a block (approved block), a transaction(s) (transaction records regarding Bitcoin), and the like used for a management of Bitcoin via Internet.

The management of Bitcoin is performed by a transaction ledger called a blockchain. In the block chain, a plurality of blocks is connected in cascade (in a straight line), and each block includes a plurality of transactions that are traded in the past. An operation of adding a block including a newly generated unapproved transaction to the blockchain is the mining operation of Bitcoin.

The above mentioned mining operation is performed by a Bitcoin participant(s) (miners) around the world, and the miner who generated an approved block from an unapproved block obtains the Bitcoin as a reward. At the time of the application of the present invention, the miner who has successfully mined can obtain the Bitcoin equivalent to a commission generated from each transaction and a Bitcoin (mined Bitcoin) obtained by approving the unapproved block.

The mining unit 33 performs the mining operation using the surplus power supplied from the power plant 10, and obtains the Bitcoin.

The mining operation by the mining unit 33 is performed in brief as follows.

The mining unit 33 stores the obtained transactions (records related to transmissions and reception of Bitcoins) in an area called a memory pool (not shown). After that, the mining unit 33 creates a new block from the memory pool. At that time, the mining unit 33 attempts to find a value called a nonce. The nonce is an arbitrary character string for setting a hash value of a newly generated block header to a predetermined value. For example, in Bitcoin, the nonce that sets the hash value of a newly generated block header to a value that “0 continues for a certain number” is the “nonce”.

Note that, the block header includes the hash value of a header of a previous block that has been approved, the data structure of the transaction to be stored in a newly generated block (so-called Merkle tree, hash tree), and the nonce.

The mining unit 33 is portable and has a configuration and a structure that can be easily installed at the surplus power absorption site 20. Therefore, in a case where the mining units 33 become excessive due to a seasonal factor or the like, a system administrator or the like can also move the excessive mining unit 33 to another surplus power absorption site 20.

### [Processing Configuration]

Next, a processing configuration (processing module) of each apparatus forming the surplus power absorption site 20 will be described.

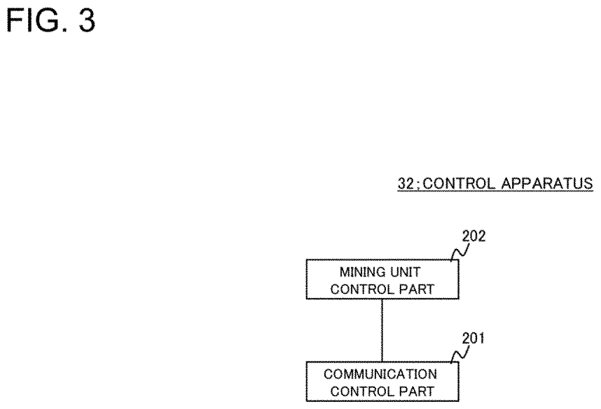

FIG. 3 is a diagram showing an example of a processing configuration of the control apparatus 32. By referring to FIG. 3, the control apparatus 32 is configured comprising, a communication control part 201 and a mining unit control part 202.

The communication control part 201 is a means that controls communication with other apparatuses (for example, the power generation control apparatus 11 and the mining unit 33). For example, when the communication control part 201 receives data (packet) related to the surplus power information from the power generation control apparatus 11, the communication control part 201 transmits the data to the mining unit control part 202. Also, the communication control part 201 transmits a control information addressed to the mining unit 33 generated by the mining unit control part 202 to the mining units 33.

The mining unit control part 202 is a means that determines to control to activate or deactivate the plurality of mining units 33 based on information related to the surplus power provided from the power plant 10 (surplus power information) and consumed power information of each of the plurality of mining units 33. Note that the consumed power information of the mining unit 33 is stored in a storage part (not shown) as a part of a mining unit information.

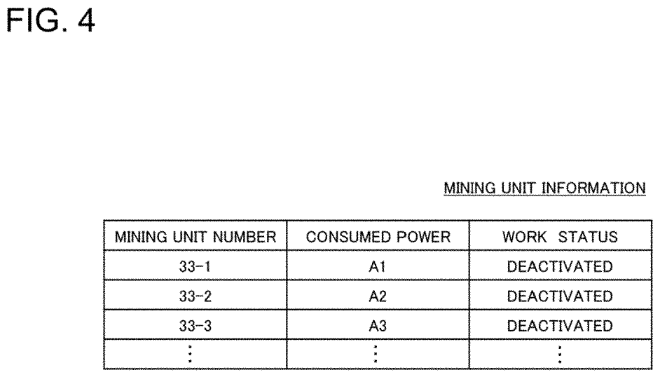

FIG. 4 is a diagram showing an example of the mining unit information stored in the storage part. By referring to FIG. 4, each of the mining units 33 and consumed power thereof are stored in association with each other as a mining unit information. Also, the mining unit information includes a work status (activated or deactivated) for each of mining units 33. The mining unit control part 202 updates the mining unit information each time that the operation status of each of mining units 33 is changed.

The mining unit control part 202 determines the mining units 33 to be activated among the plurality of mining units 33 within an extent in which the total value of the consumed power of the activated mining units 33 does not exceed the surplus power. More concretely, the mining unit control part 202 determines the mining units 33 to be activated so that the total consumed power of the activated mining units 33 is maximized within an extent not exceeding the surplus power.

The mining unit control part 202 determines the mining units 33 to be activated (let them perform mining work) so as to consume the surplus power (surplus power described in the surplus power information) supplied from the power plant 10 as much as possible. For example, at the initial timing when there are no activated mining units 33, the mining unit controller 202 activates the mining units 33 among the plurality of mining units 33 so that a largest amount of power is consumed within an extent not exceeding the surplus power. After that, the mining unit control part 202 transmits a “mining start instruction” to the determined mining units 33.

For example, consider a case where the surplus power is 1000 KW, the consumed power of the mining unit 33-1 is 300 KW, the consumed power of the mining unit 33-2 is 400 KW, and the consumed power of the mining unit 33-3 is 500 KW. In this case, the combination of the mining units 33 that can consume the most surplus power is the mining unit 33-2 and the mining unit 33-3. Therefore, the mining unit control part 202 transmits the “mining start instruction” to these mining units 33.

Alternatively, when the surplus power information is obtained during the operation of the system, the mining unit control part 202 compares the surplus power included in the surplus power information obtained immediately before with the surplus power included in the latest surplus power information, and calculate the amount of change in the surplus power. The mining unit control part 202 controls activation and deactivation of the mining units 33 according to the calculated change amount of the surplus power. Concretely, in a case where the surplus power is increasing, the mining unit control part 202 determines the mining units 33 to be activated among the mining units 33 of deactivated status so that the increased surplus power can be consumed as much as possible. After that, the mining unit control part 202 transmits the “mining start instruction” to the determined mining units 33.

On the other hand, in a case where the surplus power is reduced, the mining unit control part 202 determines the mining units 33 to be deactivated among the mining units 33 of activated status so that the power corresponding to the reduced surplus power is reduced. After that, the mining unit control part 202 transmits a “mining stop instruction” to the determined mining units 33.

As described above, the mining unit control part 202 controls the mining units 33 based on the surplus power information provided from the power plant 10 and table information (mining unit information).

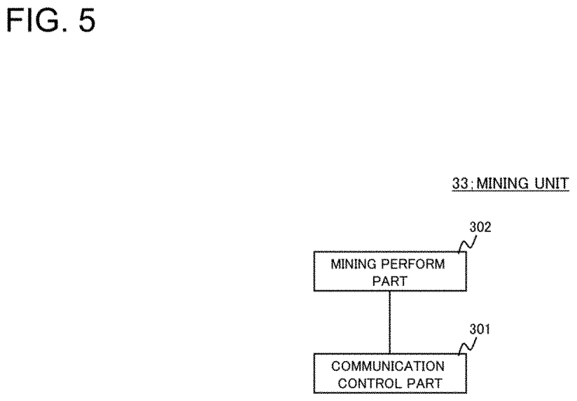

FIG. 5 is a diagram showing an example of a processing configuration of the mining unit 33. By referring to FIG. 5, the mining unit 33 is configured to comprise a communication control part 301 and a mining perform part 302.

The communication control part 301 is a means that controls processing with other apparatuses (the control apparatus 32, a terminal on the Internet, a server, or the like). For example, when obtained the control information (mining start instruction, mining stop instruction) from the control apparatus 32, the communication control part 301 transmits the control information to the mining perform part 302.

The mining perform part 302 is a means that performs a Bitcoin mining operation. Before the mining perform part 302 is transmitted the mining start instruction, the mining perform part 302 is in so-called a sleep mode (low-power operation mode). The consumed power of the mining units 33 of the mining perform part 302 in the sleep mode can be almost ignored. In other words, the mining operation by the mining perform part 302 requires a large amount of power consumption, and when compared with the power, the consumed power by the communication control part 301 and the mining perform part 302 in the sleep mode is extremely small.

The mining perform part 302 is activated when the mining start instruction is transmitted, and starts mining operation of Bitcoin (approving work of unapproved blocks). On the other hand, when the mining perform part 302 is transmitted the mining stop instruction, the mining perform part 302 stops the Bitcoin mining operation and transits to the sleep mode.

### [Hardware Configuration]

Next, a hardware configuration of the control apparatus 32 will be described.

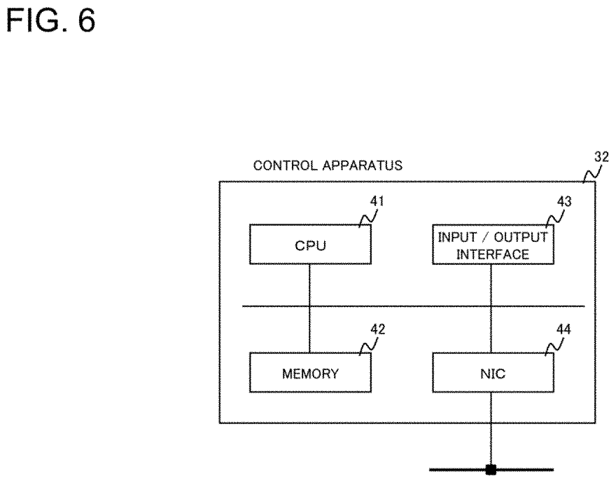

FIG. 6 is a diagram showing an example of a hardware configuration of the control apparatus 32. The control apparatus 32 can be configured by so-called an information processing device (computer), and has a configuration shown in FIG. 6. For example, the control apparatus 32 comprises a CPU (Central Processing Unit) 41, a memory 42, an input/output interface 43, an NIC (Network Interface Card) 44 as communication means, and the like, which are mutually connected by an internal bus.

The configuration shown in FIG. 6 is not intended to limit the hardware configuration of the control apparatus 32. The control apparatus 32 may include a hardware(s) (not shown). Also, the number of CPUs and the like included in the control apparatus 32 is not limited to the example shown in FIG. 6, for example, a plurality of CPUs may be included in the control apparatus 32.

The memory 42 is a RAM (random access memory), a ROM (read only memory), or an auxiliary storage device (such as a hard disk).

The input/output interface 43 is a means serving as an interface for a display device and an input device (not shown). The display device is, for example, a liquid crystal display or the like. The input device is a device that receives a user operation such as a keyboard or a mouse for example.

The functions of the control apparatus 32 are realized by the processing modules described above. The processing modules are realized, for example, by the CPU 41 executing a program stored in the memory 42. Also, the program can be downloaded via a network or updated using a storage medium storing the program. Further, the processing modules may be realized by a semiconductor chip(s). That is, the functions performed by the processing modules may be realized by executing a software on some hardware.

Since a hardware configuration of the mining unit 33 can be the same as that of the control apparatus 32, the description thereof is omitted.

### [System Operation]

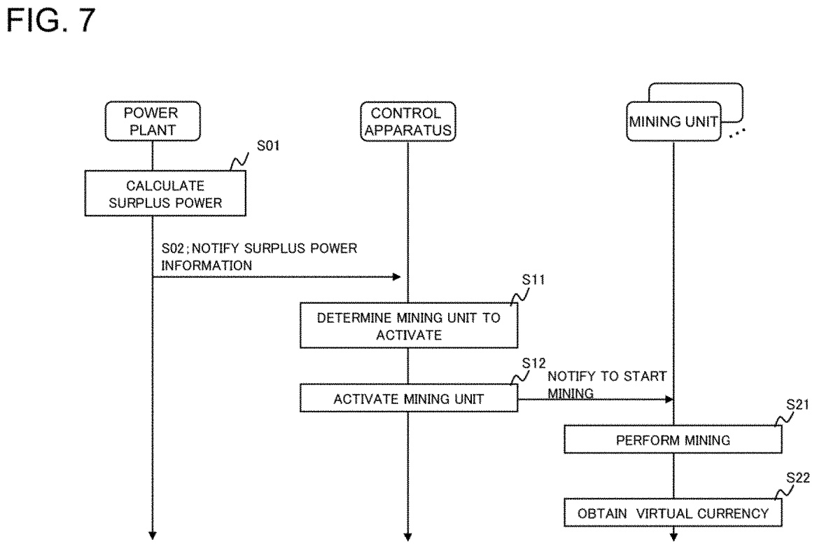

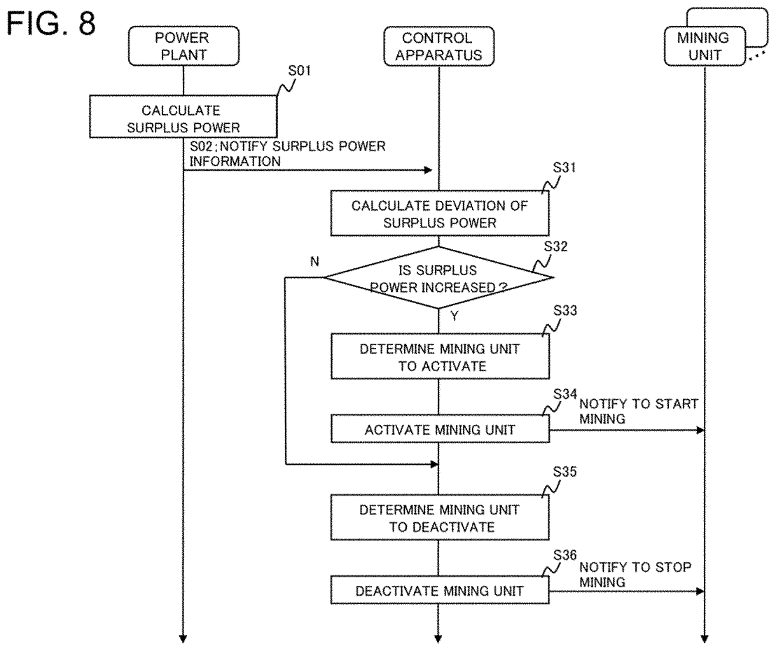

Next, an operation of the surplus power absorption system according to the first exemplary embodiment will be described with reference to FIG. 7 and FIG. 8.

FIG. 7 is a sequence diagram showing an example of an operation of the surplus power absorption system according to the first exemplary embodiment. FIG. 7 shows the operation at the time of initial startup of the system.

The power generation control apparatus 11 in the power plant 10 calculates the surplus power at a predetermined timing (for example, a predetermined datetime) or at a predetermined interval (for example, every several minutes) (Step S01). Since the calculation of the surplus power is evident to those skilled in the art, details will be omitted, however, the surplus power can be calculated by subtracting the power supplied to the consumers via the power supply line and the power supply grid from the power generation amount by the power generation system 12.

The power plant 10 notifies to the control apparatus 32 of information including the calculated surplus power as “surplus power information” (Step S02).

Since FIG. 7 is a diagram showing an operation at the time of starting of the system, the surplus power information becomes information that the surplus power absorption site 20 firstly obtained. The control apparatus 32 determines the mining units 33 to be activated based on the surplus power information and the mining unit information (Step S11). Concretely, the control apparatus 32 determines the mining units to be activated, such that the consumed power at the surplus power absorption site 20 when the mining units 33 are activated becomes closest to the surplus power described in the surplus power information.

The control apparatus 32 activates the mining units 33 by transmitting the “mining start instruction” to the determined mining units 33 (Step S12).

The mining units 33 that are transmitted the mining start instruction starts the Bitcoin mining operation (mining) (Step S21).

In a case where the mining is successful (successful discovery of predetermined nonce), the mining unit 33 obtains Bitcoin (Step S22).

Information on the obtained Bitcoin is transmitted to the control apparatus 32 as appropriate, and a total amount of the obtained Bitcoin and the like in the entire surplus power absorption site 20 is managed. Alternatively, a monitor such as a liquid crystal panel may be connected to the control apparatus 32 to display the total amount of Bitcoins mined in real time.

As described above, note that the number of miners who succeed in mining a Bitcoin is limited to one (one terminal or the like), so that in a case there is a miner that has successfully mined before the mining unit 33, the surplus power absorption site 20 cannot obtain the Bitcoin. On the other hand, a mechanism called “mining pool” exists for mining Bitcoins. The mining pool is a mechanism in which a plurality of miners cooperates to mine, and in a case where a member of the group succeeds in mining, a part of the reward is also given to the participants of the group. Therefore, the possibility of obtaining Bitcoin may be increased by joining all or part of the mining units 33 to the mining pool.

FIG. 8 is a sequence diagram showing an example of the operation of the surplus power absorption system according to the first exemplary embodiment. FIG. 8 shows the operation while in operation of the system that has already been started.

As described above, the power plant 10 calculates the surplus power and notifies to the control apparatus 32 of the surplus power information (Steps S01, S02).

When the system is already operating (when the surplus power information has been obtained in the past), the control apparatus 32 calculates an amount of change in the surplus power based on the surplus power information obtained immediately before and the latest surplus power information (Step S31).

The control apparatus 32 determines whether the surplus power has increased based on the calculated change amount (Step S32).

In a case where the surplus power has increased (Step S32, Yes branch), the control apparatus 32 determines the mining units 33 to be additionally activated, and transmits the “mining start instruction” to the determined mining units 33. (Step S33, S34).

In a case where the surplus power has decreased (Step S33, No branch), the control apparatus 32 determines the mining units 33 to be deactivated, and transmits the “mining stop instruction” to the determined mining units 33. (Step S35, S36).

Note that, in FIG. 8, descriptions regarding the operation of the mining units 33 in cases where the mining start instruction or the mining stop instruction are received is omitted.

Although not shown in FIG. 7 and FIG. 8, the surplus power absorption site 20 may not be able to absorb (consume) all of the surplus power generated in the power plant 10. In such a case, the control apparatus 32 may notify to the power plant 10 or its business operator (electric power company) that all of the surplus power cannot be absorbed or the amount of the surplus power that cannot be absorbed.

As described above, at the surplus power absorption site 20 according to the first exemplary embodiment, the surplus power generated in the power plant 10 is supplied, and the surplus power is utilized to perform mining (mining) of the virtual currency. The mined virtual currency is the monetary value itself, and the surplus power absorption site 20 converts the surplus power of the power plant 10 into the monetary value.

By such the functions of the surplus power absorption site 20, the ratio of thermal power(s) plant or the like which has been a power source for adjusting supply power can be significantly reduced. That is, in the first exemplary embodiment, hydroelectric power or the like that has difficulty in controlling output but has a light load to the environment is set as a main power supply, so that the main power supplies most of the power required by the consumers. At this time, in the main power supply, the surplus power that cannot be easily adjusted in the supplied power is converted into money. As a result, it becomes possible to balance supply and demand without imposing the load to the environment and at a low cost (in some cases, obtaining profit). That is, the cost required for the excessively generated power is compensated for by the money called as virtual currency, and the cost required for the entire power generation can be reduced. Also, in the case of hydroelectric power and the like, unlike thermal power, the load to the environment is light.

### Second Exemplary Embodiment

Next, a second exemplary embodiment will be described in detail with reference to the drawings.

In the first exemplary embodiment, the surplus power generated in the power plant 10 is absorbed by transmitting the control information (mining start instruction, mining stop instruction) from the control apparatus 32 to the mining units 33. In the second exemplary embodiment, the surplus power is absorbed by controlling the power supplied to the mining units 33.

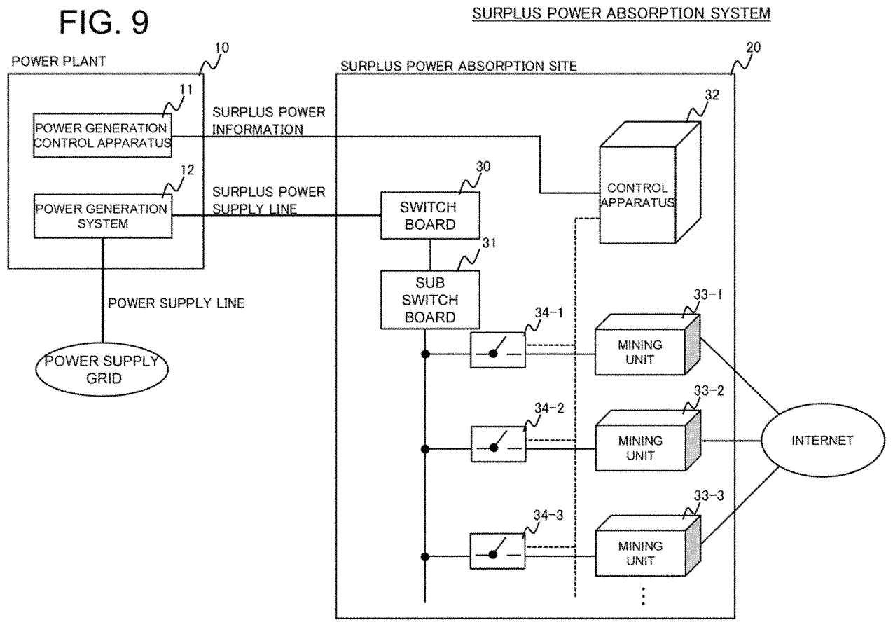

As shown in FIG. 9, the surplus power absorption site 20 according to the second exemplary embodiment comprises a switch 34 corresponding to each mining units 33. The switch 34 is connected between the sub switch board 31 and the mining unit 33.

The mining unit control part 202 sets the corresponding switch 34 to ON when activating the mining unit 33. The mining unit control part 202 sets the corresponding switch 34 to OFF when deactivating the mining unit 33.

The mining unit 33 to which the power has been supplied automatically starts the Bitcoin mining operation after being started.

As described above, consumption of the surplus power may be realized by directly controlling the power supplied to each of the mining units 33. As a result, the mining units 33 in deactivated status do not consume power, and the control apparatus 32 can control consumption of the surplus power more accurately.

### Third Exemplary Embodiment

Next, a third exemplary embodiment will be described in detail with reference to the drawings.

In the third exemplary embodiment, description will be given on the control apparatus 32 that utilizes information on the power actually consumed at the surplus power absorption site 20. In the first and second exemplary embodiments, the control apparatus 32 controls the mining units 33 using the surplus power information. However, it has not been confirmed whether the surplus power supplied from the power plant 10 is surely consumed at the surplus power absorption site 20.

For example, even if the control apparatus 32 transmits the “mining start instruction” to the mining unit 33, there is a possibility that the mining operation is not actually performed due to a defect of the mining unit 33 or the like. When such a situation occurs, part of the surplus power originally scheduled to be consumed at the surplus power absorption site 20 is not consumed, and the conversion of the surplus power to the monetary value will not be properly performed.

In view of the above, the control apparatus 32 according to the third exemplary embodiment obtains information on the consumed power at the surplus power absorption site 20 from the switchboard 30 and utilizes the information for controlling the mining units 33.

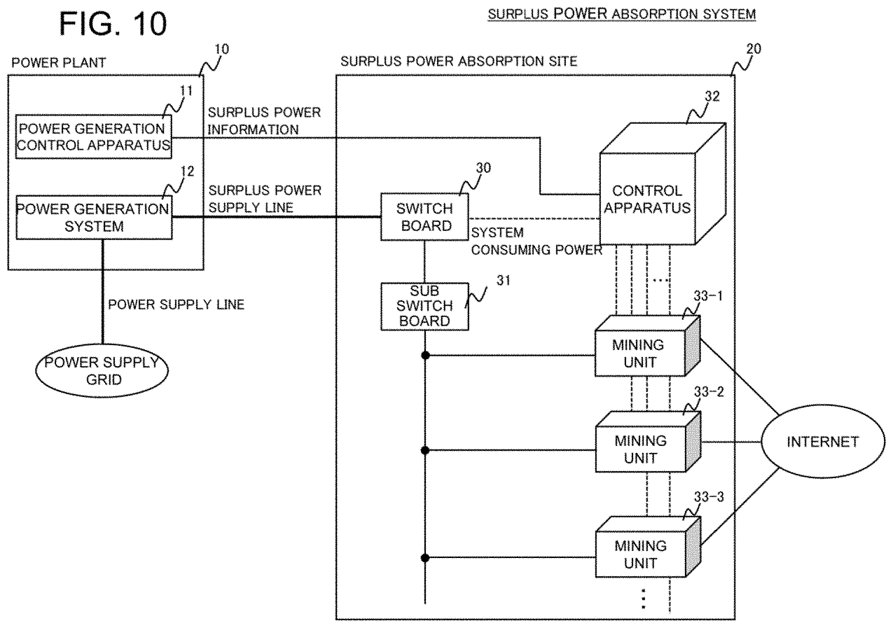

In the surplus power absorption site 20 according to the third exemplary embodiment, as shown in FIG. 10, the control apparatus 32 and the switchboard 30 are connected, and the control apparatus 32 is configured to be able to obtain the power consumed at the surplus power absorption site 20. That is, the switchboard 30 measures the power consumed at the surplus power absorption site 20, and the control apparatus 32 is configured to be able to obtain a measured value of the power consumed. Note that, as described above, the power consumed in the surplus power absorption site 20 is substantially equal to the power consumed in the mining units 33 in the activated status. Also, in FIG. 10, the configuration in which the control apparatus 32 obtains the measured value of the power consumed from the switchboard 30 is shown, however it is needless to say that the control apparatus 32 may be configured to obtain the measured value from the sub switch board 31.

Hereinafter, the operation of the mining unit control part 202 included in the control apparatus 32 according to the third exemplary embodiment will be described focusing on differences from the operation described in the above exemplary embodiments.

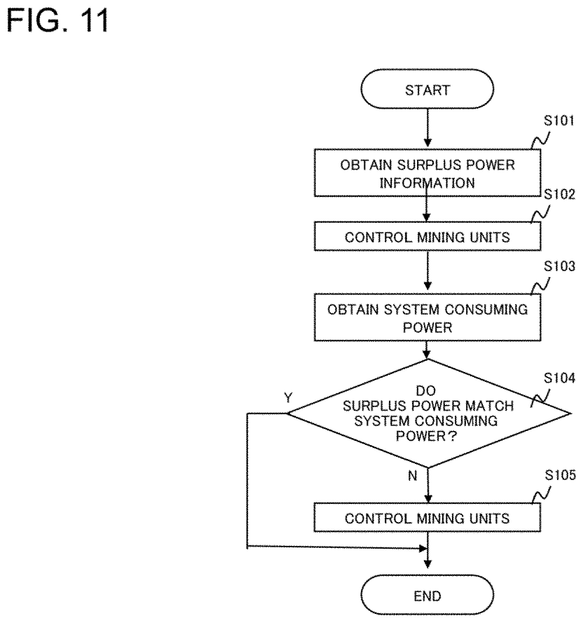

FIG. 11 is a flowchart showing an example of an operation of the mining unit control part 202 according to the third exemplary embodiment.

The mining unit control part 202 obtains the surplus power information from the power plant 10 and controls the mining units 33 based on the surplus power information and the mining unit information (Step S101, S102).

The mining unit control part 202 accesses the switch board 30 and obtains the measured value of power consumed (hereinafter, referred to as system consuming power) at the surplus power absorption site 20 (step S103).

The mining unit control part 202 determines whether the surplus power substantially matches the system consuming power (Step S104). For example, in a case a difference between the surplus power and the system consuming power falls within a predetermined range, it is determined that the two powers substantially match. As described above, the mining unit control part 202 determines whether the surplus power generated in the power plant 10 is absorbed at the surplus power absorption site 20 as expected.

In a case where the surplus power and the system consuming power substantially match (Step S104, Yes branch), the mining unit control part 202 terminates the processing.

In a case where the surplus power does not substantially match the system consuming power (Step S104, No branch), the mining unit control part 202 controls the mining units 33 so that the system consuming power becomes substantially the same as the surplus power. (Step S105).

Concretely, in a case where the system consuming power is smaller than the surplus power, the mining unit control part 202 additionally activates the mining units 33 so as to bridge the power difference. On the other hand, in a case where the system consuming power is larger than the surplus power, the mining unit control part 202 deactivates the mining units 33 so as to bridge the power difference. As described above, the mining unit control part 202 controls the mining units 33 based on the measured value of the power consumed by the activated mining unit 33 such that the total value of the surplus power and the total power consumed in the activated mining units 33 match.

Note that, in the third exemplary embodiment, the control apparatus 32 is configured to be able to obtain the power actually consumed at the surplus power absorption site 20. Therefore, the control apparatus 32 may output information on the measured value of the power consumed by the activated mining units to an outside. For example, the control apparatus 32 may report the system consuming power to the power plant 10 or its business entity (electric power company). The business entity or the like receiving the report can confirm that the generated surplus power is appropriately consumed (absorbed).

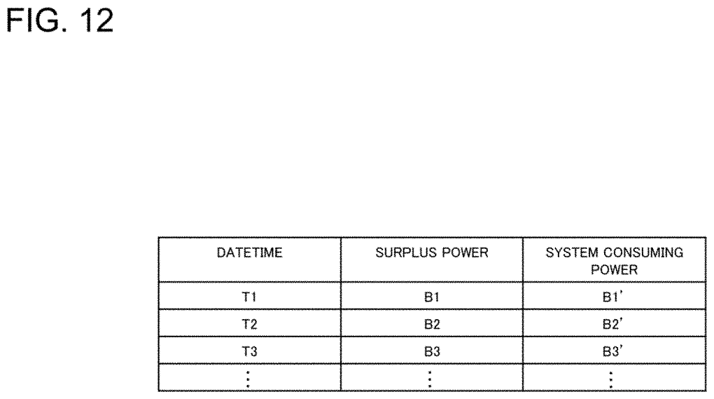

Alternatively, the control apparatus 32 may report the surplus power information obtained from the power plant 10 in association with the system consuming power. For example, the control apparatus 32 may generate information as shown in FIG. 12 based on the surplus power information and the system consuming power, and report the information to the power plant 10 or the like.

As described above, in the third exemplary embodiment, the power actually consumed at the surplus power absorption site 20 is fed back to the control of the mining units 33, thereby enabling more accurate consumption of the surplus power.

### Fourth Exemplary Embodiment

Next, a fourth exemplary embodiment will be described in detail with reference to the drawings.

In the fourth exemplary embodiment, the control apparatus 32 that determines whether the mining units 33 in the surplus power absorption site 20 are on excess or shortage will be described. Since the system configuration of the fourth exemplary embodiment has no difference from the system configuration of the first exemplary embodiment, the description corresponding to FIG. 2 is omitted.

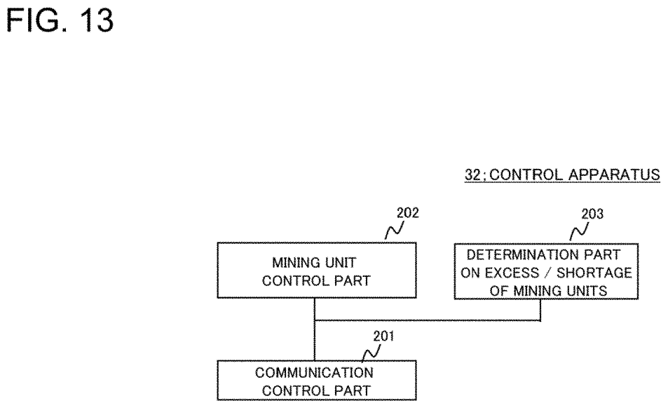

FIG. 13 is a diagram showing an example of a processing configuration of the control apparatus 32 according to the fourth exemplary embodiment. As shown in FIG. 13, the control apparatus 32 according to the fourth exemplary embodiment further comprises a determination part on excess or shortage of mining units 203.

Hereinafter, an operation of the determination part on excess or shortage of mining units 203 will be mainly described.

The determination part on excess or shortage of mining units 203 is a means of determining excess or shortage of the plurality of mining units 33 included in the surplus power absorption site 20 based on a peak value of the surplus power in a predetermined period of time and the power value that can be consumed by the plurality of mining units 33. Also, the determination part on excess or shortage of mining units 203 outputs information regarding an arrangement of the mining units 33 based on a determination result on excess or shortage of the mining units 33.

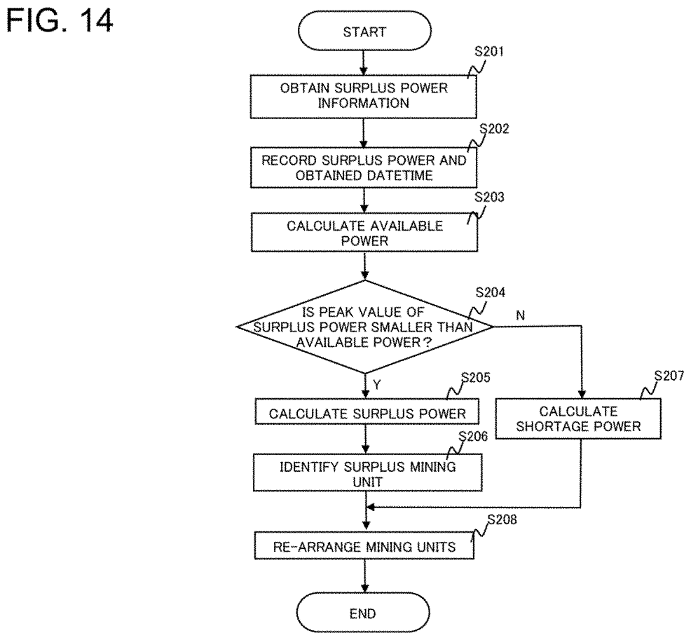

FIG. 14 is a flowchart showing an example of an operation of the determination part on excess or shortage of mining units 203 according to the fourth exemplary embodiment.

The determination part on excess or shortage of mining units 203 obtains the surplus power information (Step S201).

The determination part on excess or shortage of mining units 203 records the surplus power included in the surplus power information and obtained date-time in association with each other (Step S202).

When an accumulation of the surplus power for a predetermined period (for example, one week or one month) is completed, the determination part on excess or shortage of mining units 203 determines whether the mining units 33 are excessive or insufficient at the surplus power absorption site 20 based on the accumulated surplus power and the mining unit information.

Concretely, the determination part on excess or shortage of mining units 203 refers to the mining unit information and calculates the total value of the consumed power by each of mining units 33 described in the information as “available power” (Step S203).

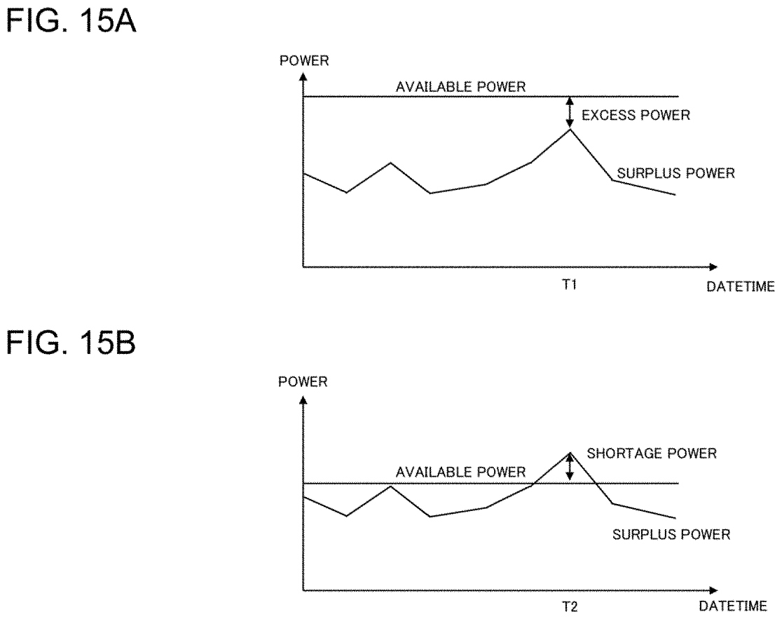

As a result, for example, a relationship between the surplus power and available power as shown in FIG. 15 is obtained.

Next, the determination part on excess or shortage of mining units 203 determines whether a peak value of the accumulated surplus power is smaller or larger than the available power (Step S204).

In a case where the accumulated peak value of the surplus power is smaller than the available power (Step S204, Yes branch), the determination part on excess or shortage of mining units 203 determines the difference between the available power and the peak value of the surplus power as “excess power”. (Step S205).

The determination part on excess or shortage of mining units 203 refers to the mining unit information and identifies the mining units 33 that are closest to the excess power for which the sum of the consumed power by at least one or more mining units 33 has been calculated (Step S206).

The identified mining units 33 are treated as “excessive mining units”. For example, in FIG. 15A, the difference between the available power and the surplus power at time T1 is calculated as “excess power”, and at least one or more mining units 33 having the consumed power corresponding to the power are treated as the excessive mining units.

In a case where the peak value of the accumulated surplus power is larger than the available power (Step S204, No branch), the determination part on excess or shortage of mining units 203 calculates the difference between the peak value of the surplus power and the available power as “shortage power”. (Step S207). For example, in FIG. 15B, the difference between the surplus power and the available power at time T2 is calculated as “shortage power”.

Although not shown in FIG. 14, it is ideal that the surplus power and the available power substantially match. Therefore, in a case where these powers match, the determination part on excess or shortage of mining units 203 determines that there is “no excess or shortage”.

The determination part on excess or shortage of mining units 203 outputs information on “excessive mining units” or “shortage power”, and instructs a rearrangement of the mining units 33. For example, the determination part on excess or shortage of mining units 203 displays the information on a monitor such as a liquid crystal panel, prints the information, and/or transfers the information to a predetermined terminal or the like. A system administrator or the like who has contacted the information moves the excessive mining units to another surplus power absorption site 20, or adds the mining units 33 to the surplus power absorption site 20 so as to absorb the shortage power. As described above, since the mining units 33 are configured to be detachable at the surplus power absorption site 20, the mining units 33 may be moved (rearranged) by a truck or the like.

As described above, in the fourth exemplary embodiment, the operation status of the mining units 33 in the surplus power absorption site 20 is analyzed, and occurrence of excessive power or shortage of power is detected. Concretely, in a case where the peak value of the surplus power is smaller than the power that can be consumed by the plurality of mining units 33, the control apparatus 32 according to the fourth exemplary embodiment determines that the plurality of mining units are excessive mining units. On the other hand, in a case where the peak value of the surplus power is larger than the power that can be consumed by the plurality of mining units 33, the control apparatus 32 determines that the mining units 33 is in short in the system. Further, the control apparatus 32 outputs information on the arrangement (rearrangement) of the mining units 33 based on a determination result regarding the excess or shortage of the mining units 33. That is, in the fourth exemplary embodiment, in a case where there is excess power or shortage power, the mining units 33 are rearranged so as to eliminate these. As a result, the arrangement of the mining units 33 is optimized, and limited resources can be efficiently utilized.

### Fifth Exemplary Embodiment

Next, a fifth exemplary embodiment will be described in detail with reference to the drawings.

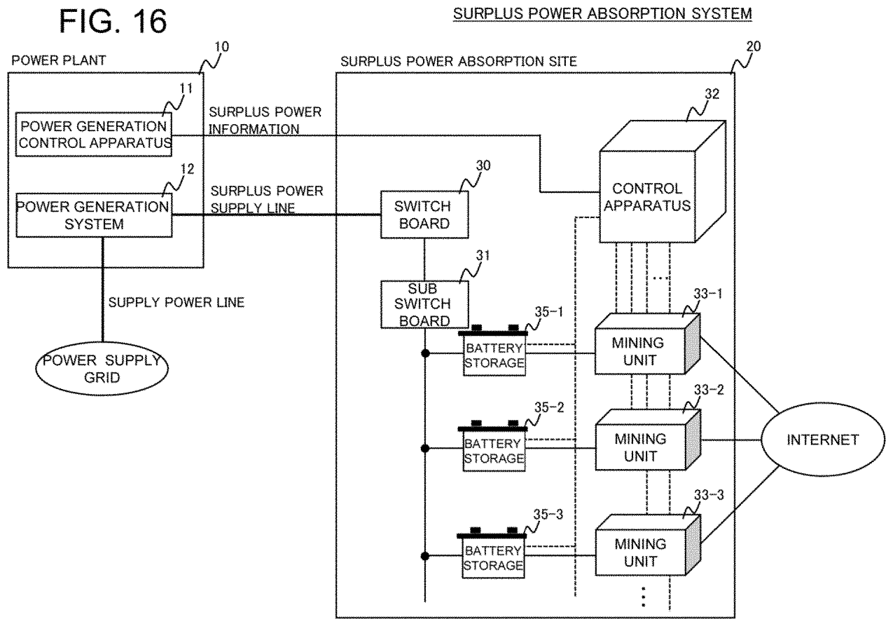

In the fifth exemplary embodiment, a battery storage(s) 35 is connected to each of the mining units 33, and the battery storage(s) 35 are used for absorbing the surplus power. As shown in FIG. 16, the surplus power absorption site 20 according to the fifth exemplary embodiment comprises the battery storage(s) 35 corresponding to each of the mining units 33.

The battery storage 35 is a battery storage such as a lithium ion battery, and is connected between the sub switch board 31 and the mining unit 33. The battery storage 35 is configured to charge power from the sub switch board 31 and supply the charged power to the mining unit 33. Further, the battery storage 35 has a built-in switch, and is configured to be able to switch between supplying the power from the sub switch board 31 to the mining unit 33 and supplying the charged power to the mining unit 33.

The mining unit control part 202 controls charging and discharging of the battery storage 35 and switching of the power system. Also, the mining unit control part 202 manages the status of the battery storage 35 (charging, discharging, or unused) and the charged rate using the mining unit information. Note that the battery storage 35 is discharging indicates a status in which the battery storage 35 and the mining unit 33 are connected and power is supplied from the battery storage 35 to the mining unit 33. The battery storage 35 unused indicates a status in which the battery storage 35 is not charging, as well as is not connected to the mining unit 33.

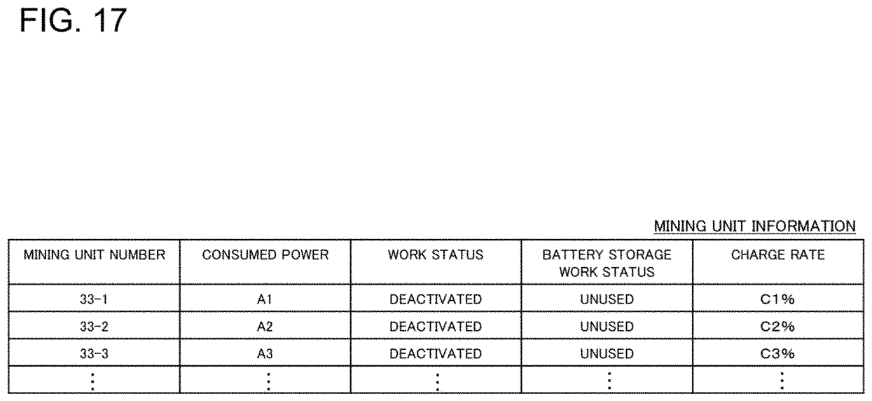

The mining unit control part 202 manages the status and the charged rate of the battery storage 35 in association with the corresponding mining unit 33. Concretely, as shown in FIG. 17, the mining unit control part 202 manages the status of the battery storage 35 using the mining unit information.

Hereinafter, among operations of the mining unit control part 202 according to the fifth exemplary embodiment, differences from the operations described in the above embodiment will be mainly described.

The mining unit control part 202 according to the fifth exemplary embodiment gives priority to a consumption of surplus power by the mining units 33 existing in the surplus power absorption site 20. In other words, the mining unit control part 202 absorbs the surplus power by charging the battery storage 35 in a case where the surplus power cannot be consumed by the mining units 33 themselves.

Also, in a case where the surplus power generated in the power plant 10 is lower than the “available power” described in the fourth exemplary embodiment, the mining unit control part 202 utilizes the power charged in the battery storage 35 so as to activate as many mining units 33 as possible. That is, the mining unit control part 202 according to the fifth exemplary embodiment makes a time during which the mining units 33 are activated as long as possible, and efficiently converts the surplus power into the monetary value.

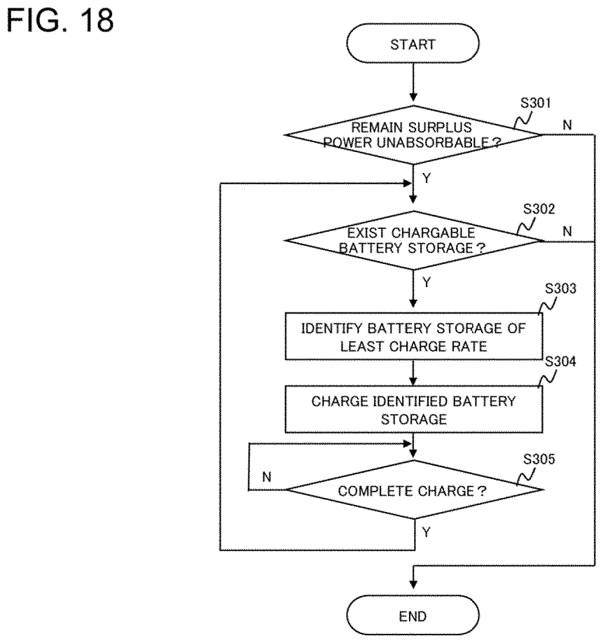

FIG. 18 is a flowchart showing an example of an operation of the mining unit control part 202 according to the fifth exemplary embodiment. FIG. 18 shows the operation in a case where the surplus power cannot be absorbed only by activation of the mining units 33.

The mining unit control part 202 determines whether there remains power that is unabsorbed by the operation of the mining units 33 (Step S301). For example, the mining unit control part 202 determines above determination based on whether the surplus power is smaller than the available power.

In a case where there remains no surplus power that is unabsorbable (Step S301, No branch), the mining unit control part 202 terminates the process.

In a case where there remains power that is unabsorbable (Step S301, Yes branch), the mining unit control part 202 refers to the mining unit information and determines whether or not there exist a chargeable battery storage(s) 35 (Step S302). Concretely, it is determined whether or not there is the battery storage 35 whose operation status is unused and whose charged rate is equal to or less than a predetermined value (for example, 95%).

In a case where there exists the chargeable battery storage 35 (Step S302, Yes branch), the mining unit control part 202 identifies the storage battery 35 with the lowest charge rate from the plurality of battery storage 35 (Step S303).

The mining unit control part 202 controls and charges the battery storage 35 so that the power of the sub switch board 31 is supplied to the identified battery storage 35 (Step S304).

The mining unit control part 202 monitors completion of charging of the battery storage 35 (Step S305). When charging is completed (Step S305, Yes branch), the mining unit control part 202 returns to step S302. That is, the mining unit control part 202 repeatedly determines whether or not the chargeable battery storage 35 exists and charges the battery storage 35 repeatedly.

In a case where there exists no chargeable battery storage 35 (Step S302, No branch), the mining unit control part 202 terminates the process.

Note that the mining unit control part 202 sequentially reflects the status and the charged rate of the battery storage 35 in the mining unit information.

As described above, in a case where the surplus power is larger than the power that can be consumed (absorbable) by the plurality of mining units 33, the mining unit control part 202 charges at least one or more of the pluralities of battery storages 35.

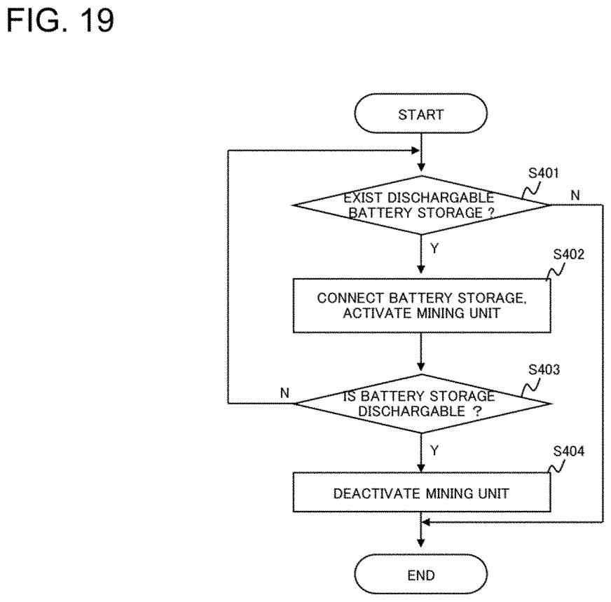

FIG. 19 is a flowchart showing an example of an operation of the mining unit control part 202 according to the fifth exemplary embodiment. FIG. 19 shows the operation in a case where the power charged in the battery storage 35 is used.

The mining unit control part 202 refers to the mining unit information and determines whether or not the corresponding battery storage 35 that is in the deactivated mining units 33 can be discharged (Step S401). Concretely, the mining unit control part 202 determines whether or not the charged rate of battery storage 35 corresponding to the mining unit 33 in the deactivated status is equal or higher than a predetermined value (for example, 50% or higher).

In a case where there is no such mining unit 33 (Step S401, No branch), the mining unit control part 202 terminates the processing.

In a case where the mining unit 33 as described above exists (Step S401, Yes branch), the mining unit control part 202 connects the battery storage 35 to the mining unit 33, discharges the battery storage 35, and activates the mining unit 33 (Step S402).

The mining unit control part 202 monitors the charged rate of the battery storage 35 during discharging, and determines whether or not the discharging storage battery 35 has transitioned to a status where discharge is impossible (Step S403). Concretely, the mining unit control part 202 determines whether or not there is a storage battery 35 whose charged rate is equal or less than a predetermined value (for example, 10% or less).

In a case where there exists a battery storage 35 that cannot be discharged (Step 403, Yes branch), the mining unit control part 202 controls the mining unit 33 connected to the storage battery 35 to be deactivated (Step S404).

In a case where the battery storage 35 does not exist (Step S403, No branch), the mining unit control part 202 repeats the processing from Step S401.

The mining unit control part 202 sequentially reflects the status of the mining units 33, the status of the battery storage 35, and the charged rate in the mining unit information.

As described above, the mining unit control part 202 determines whether the deactivated mining unit 33 exists among the plurality of mining units 33 and determines whether the charging of the battery storage 35 connected to the deactivated mining unit 33 is completed. In a case where the charging of the battery storage 35 is completed, the mining unit control part 202 activates the deactivated mining unit 33 by the charged power of the storage battery 35.

Note that, the operation shown in FIG. 19 is on the assumption that there is no change in the surplus power supplied from the power plant 10. That is, before the operation of the mining unit control part 202 shown in FIG. 19 starts, the mining units 33 that only absorbs the surplus power is operating. In such a situation, in a case where there exists no charged storage battery 35, the mining units 33 cannot be additionally operated. If the mining units 33 is additionally operated, a power more than the surplus power notified from the power plant 10 will be consumed. That is, after the power of the battery storage 35 is exhausted, the mining units 33 cannot continue to operate. Therefore, in Step S404 in FIG. 19, the mining unit 33 that is operating by supplying power from the battery storage 35 is stopped. However, in a case where there is a margin in the surplus power that can be used in Step S404, the mining unit control part 202 can continue the operation of the mining units 33.

As described above, the mining unit control part 202 according to the fifth exemplary embodiment charges the surplus power in the battery storage 35 in a case where the surplus power generated in the power plant 10 is unabsorbable by activating the mining units 33. Further, in a case where the mining unit 33 that is not operating exists and the corresponding battery storage 35 has sufficient power charged therein, the mining unit control part 202 supplies the mining unit 33 the power from the battery storage 35 instead of the surplus power, and let it mine. As a result, the surplus power can be more efficiently utilized. That is, since the operation time of the mining units 33 becomes longer, more Bitcoins can be obtained.

Note that the configurations of the surplus power absorption site 20 and each apparatus described in the first to fifth exemplary embodiments are merely examples, and do not intend to limit the configuration of the system and the like.

For example, in the above-described embodiments, the modes in which the power plant 10 notifies the surplus power to the surplus power absorption site 20 in real time is described, however, in a case where the consumed power is known in advance, the notification is unnecessary. For example, in a case where it is known that a large amount of the surplus power is generated at night and the surplus power is small during the day or the like, the surplus power absorption site 20 can determine the surplus power to consume without receiving the notification of the surplus power from the power plant 10.

In the above exemplary embodiments, the case where the switch board 30 is included in the surplus power absorption site 20 has been described, however, the function of the switchboard 30 may be provided in the power plant 10. Concretely, the surplus power supplied from the power plant 10 may be low-voltage power such as 100 V or 200 V.

In the above exemplary embodiments, the control apparatus 32 and the mining units 33 are described as separate housings, but these apparatuses may be integrated. One computer may include the mining module for mining virtual currency and a control module for controlling the mining module.

In the above exemplary embodiments, the mining units 33 and the power consumption are managed by table information called mining unit information. The management using the table information on the assumption that the consumed power of each of mining units 33 is different. In other words, in a case where the consumed power of each of mining units 33 is the same, it is not necessary to manage the consumed power based on the mining unit information (table information). Also, in a case where the consumed power of each of the mining units 33 is the same, basically, the consumed power at the surplus power absorption site 20 is proportional to the number of activated mining units 33. Therefore, in this case, the control apparatus 32 only needs to determine the number of the mining units 33 to be activated based on the surplus power.

However, it is desirable to use mining units 33 having different consumed power, in consideration of the degree of freedom and accuracy of control relating to the surplus power absorption at the surplus power absorption site 20. Concretely, in a case where the consumed power of each of mining units 33 is the same and the consumed power is large, the surplus power control at the surplus power absorption site 20 becomes coarse (control with low resolution). In this case, the surplus power that cannot be completely consumed by the surplus power absorption site 20 increases, which hinders efficient conversion of the surplus power into the monetary value.

In the above exemplary embodiments, the control apparatus 32 controls only activation and deactivation of the mining units 33, however, the control apparatus 32 may perform control for realizing efficient mining operation. For example, instead of starting the initial value in the calculation of the nonce from zero, the control apparatus 32 may instruct under consideration of the situation of the mining unit 33 that is already performing the mining and performs the calculation related to the discovery of the nonce from a value to other than zero.

In the first exemplary embodiment, the control apparatus 32 transmits the control information (mining start instruction, mining stop instruction) to the mining units 33 to control the mining units 33. Also, in the second exemplary embodiment, the control apparatus 32 controls the mining units 33 by directly controlling the power supplied to the mining units 33 (on/off of the switch 34). It is needless to say that the control of the mining units 33 may be a combination of these. That is, control information may be transmitted to some of the mining units 33, while directly controlling the power supplied to some of the mining units 33.

In the fourth exemplary embodiment, it has been described that the control apparatus 32 outputs information on the rearrangement of the mining units 33. However, a control management center that centrally manages the surplus power absorption site 20 may be provided, and information regarding relocation may be output (transmitted) to the control management center. The control management center may determine the arrangement of the mining units 33 based on the information obtained from each of the surplus power absorption sites 20.

In the fifth exemplary embodiment, the case where the battery storages 35 are provided corresponding to the respective mining units 33 has been described. However, it is needless to say that the battery storage 35 may be installed for some of the mining units 33. Further, instead of installing the battery storage in correspondence with the mining unit 33, a battery storage that can use the surplus power absorption site 20 may be installed. That is, at least one battery storage having a large capacity may be prepared, and the power may be supplied to the mining unit 33 from the battery storage.

Also, in the plurality of flowcharts used in the above description, the plurality of steps (processes) are described in order, but the execution order of the steps executed in each exemplary embodiment is not limited to the described order. In each exemplary embodiment, the order of the illustrated steps can be changed within a range that does not hinder the contents, such as executing each process in parallel. Also, each of the above-described exemplary embodiments can be combined in a range where the contents do not conflict with each other.

By installing a control program for the mining units in the storage unit of the computer, the computer can function as a “control apparatus for the mining units”. Also, by causing the computer to execute a mining unit control program, the computer can execute the mining unit control method.

### [MODES]

Some or all of the above exemplary embodiments may be described as in the following supplementary modes, but are not limited to the following.

### <MODE 1>

A system according to the first aspect described above.

### <MODE 2>

The system preferably according to mode 1, wherein the control apparatus is configured to determine a mining unit(s) to activate among the plurality of mining units in a range in which sum of the consumed power by the mining units activated do not exceed the surplus power.

### <MODE 3>

The system preferably according to mode 2, wherein the control apparatus is configured to determine the mining units to activate, so as to the sum of consumed power by the mining units activated is maximized within an extent not exceeding the surplus power.

### <MODE 4>

The system preferably according to mode 3, wherein the control apparatus is configured to control to activate or deactivate the plurality of mining units such that the surplus power matches the sum of the consumed power by the mining units activated, based on a measured consumed power value measured on the mining units activated.

### <MODE 5>

The system preferably according to mode 4, wherein the control apparatus is configured to output information on the measured consumed power value measured on the mining units activated.

### <MODE 6>

The system preferably according to any one of modes 1 to 5, wherein the control apparatus is: configured to determine whether excess or shortage of the plurality of mining units included in the system, based on a peak value of the surplus power and on a consumable power value by the plurality of mining units, in a predetermined period of time.

### <MODE 7>

The system preferably according to mode 6, wherein the control apparatus is: configured to determine as excess by a part of the plurality of mining units, in a case where the peak value of the surplus power is smaller than the consumable power value by the plurality of mining units, and configured to determine as shortage of the mining units in the system, in a case where the peak value of the surplus power is larger than the consumable power value by the plurality of mining units.

### <MODE 8>

The system preferably according to mode 7, wherein the control apparatus is configured to output information on arrangement of the mining units, based on a determination result of excess or shortage of the plurality of mining units.

### <MODE 9>

The system preferably according to any one of modes 1 to 8, further comprising: a plurality of battery storages, wherein each of the plurality of battery storages is connected to each of the plurality of mining units, wherein the control apparatus is: configured to charge at least one of the battery storages among the plurality of battery storages, in a case where the surplus power is larger than the consumable power value by the plurality of mining units.

### <MODE 10>

The system according to mode 9, wherein the control apparatus is configured to activate the mining units deactivated using a power supplied from the battery storages charged, in a case where there exist the mining units deactivated among the plurality of mining units and charging to the battery storages connected to the mining units deactivated is completed.

### <MODE 11>

A control apparatus according to the second aspect described above.

### <MODE 12>

A method that controls mining unit according to third aspect described above.

### <MODE 13>

A program according to the fourth aspect described above.
Note that modes 11 to 13 are possible to be extended like the way in case of mode 1, which is extended to modes 2 to 10.

Each disclosure of the above-mentioned Patent Literatures that have been cited is incorporated herein in its entirety by reference. Modification and adjustment of each exemplary embodiment or each example are possible within the scope of the overall disclosure (including the claims) of the present invention and based on the basic technical concept of the present invention. Various combinations or selections (including partial deletion) of various disclosed elements (including each element in each claim, each element in each exemplary embodiment or each example, and each element in each drawing) are possible within the scope of the overall disclosure of the present invention. That is, the present invention naturally includes various variations and modifications that could be made by those skilled in the art according to the overall disclosure including the claims and the technical concept. With respect to numerical value range(s) described herein in particular, arbitrary numerical value(s) and a small range(s) included in the numerical value range should be construed to be specifically described even unless otherwise explicitly described.

### REFERENCE SIGNS LIST

10 Power plant
11 Power control apparatus
12 Power generation system
20 Surplus power absorption site
30 Switch board
31 Sub switch board
32,102 Control apparatus
33,33-1˜33-3 Mining unit
34,34-1˜34-3 Switch
35,35-1˜35-3 Battery storage
41 CPU (Central Processing Unit)
42 Memory
43 Input/output interface
44 NIC (Network Interface Card)
201,301 Communication control part
202 Mining unit control part
203 Determination part on excess or shortage of mining units
302 Mining performing part

What is claimed is:

1. A system, comprising:
a plurality of mining units configured to perform mining of virtual currency, and
a control apparatus configured to control to activate or deactivate the plurality of mining units based on surplus power information provided from a power plant, and on consumed power information by each of the plurality of mining units.

2. The system according to claim 1, wherein the control apparatus is:
configured to determine a mining unit(s) to activate among the plurality of mining units in a range in which sum of the consumed power by the mining units activated do not exceed the surplus power.

3. The system according to claim 2, wherein the control apparatus is:
configured to determine the mining units to activate, so as to the sum of consumed power by the mining units activated is maximized within an extent not exceeding the surplus power.

4. The system according to claim 3, wherein the control apparatus is:
configured to control to activate or deactivate the plurality of mining units such that the surplus power matches the sum of the consumed power by the mining units activated, based on a measured consumed power value measured on the mining units activated.

5. The system according to claim 4, wherein the control apparatus is:
configured to output information on the measured consumed power value measured on the mining units activated.

6. The system according to claim 1, wherein the control apparatus is:
configured to determine whether excess or shortage of the plurality of mining units included in the system, based on a peak value of the surplus power and on a consumable power value by the plurality of mining units, in a predetermined period of time.

7. The system according to claim 6, wherein the control apparatus is:
configured to determine as excess by a part of the plurality of mining units, in a case where the peak value of the surplus power is smaller than the consumable power value by the plurality of mining units, and
configured to determine as shortage of the mining units in the system, in a case where the peak value of the surplus power is larger than the consumable power value by the plurality of mining units.

8. The system according to claim 7, wherein the control apparatus is:
configured to output information on arrangement of the mining units, based on a determination result of excess or shortage of the plurality of mining units.

9. The system according to claim 1, further comprising:
a plurality of battery storages, wherein each of the plurality of battery storages is connected to each of the plurality of mining units, wherein the control apparatus is:
configured to charge at least one of the battery storages among the plurality of battery storages, in a case where the surplus power is larger than the consumable power value by the plurality of mining units.

10. The system according to claim 9, wherein the control apparatus is:
configured to activate the mining units deactivated using a power supplied from the battery storages charged, in a case where there exist the mining units deactivated among the plurality of mining units and charging to the battery storages connected to the mining units deactivated is completed.

11. A control apparatus configured to control a plurality of mining units configured to perform mining of virtual currency, wherein the control apparatus is:
configured to control to activate or deactivate the plurality of mining units based on surplus power information provided from a power plant, and on consumed power information consumed by each of the plurality of mining units.

12. A method that controls mining unit for a control apparatus configured to control a plurality of mining units configured to perform mining of virtual currency, the method comprising:
obtaining surplus power information provided from a power plant, and
controlling to control to activate or deactivate the plurality of mining units based on the surplus power information and on consumed power information consumed by each of the plurality of mining units.

13. (canceled)

14. The control apparatus according to claim 11, wherein the control apparatus is:
configured to determine a mining unit(s) to activate among the plurality of mining units in a range in which sum of the consumed power by the mining units activated do not exceed the surplus power.

15. The control apparatus according to claim 14, wherein the control apparatus is:
configured to determine the mining units to activate, so as to the sum of consumed power by the mining units activated is maximized within an extent not exceeding the surplus power.

16. The control apparatus according to claim 15, wherein the control apparatus is:
configured to control to activate or deactivate the plurality of mining units such that the surplus power matches the sum of the consumed power by the mining units activated, based on a measured consumed power value measured on the mining units activated.

17. The control apparatus according to claim 16, wherein the control apparatus is:
configured to output information on the measured consumed power value measured on the mining units activated.

18. The control apparatus according to claim 11, wherein the control apparatus is:
configured to determine whether excess or shortage of the plurality of mining units included in the system, based on a peak value of the surplus power and on a consumable power value by the plurality of mining units, in a predetermined period of time.

19. The control apparatus according to claim 18, wherein the control apparatus is:
configured to determine as excess by a part of the plurality of mining units, in a case where the peak value of the surplus power is smaller than the consumable power value by the plurality of mining units, and
configured to determine as shortage of the mining units in the system, in a case where the peak value of the surplus power is larger than the consumable power value by the plurality of mining units.

20. The control apparatus according to claim 19, wherein the control apparatus is:
configured to output information on arrangement of the mining units, based on a determination result of excess or shortage of the plurality of mining units.

21. The control apparatus according to claim 11, further comprising:
a plurality of battery storages, wherein each of the plurality of battery storages is connected to each of the plurality of mining units, wherein the control apparatus is:
configured to charge at least one of the battery storages among the plurality of battery storages, in a case where the surplus power is larger than the consumable power value by the plurality of mining units.
